(19) United States
(12) Patent Application Publication
(10) Pub. No.: US 2026/0368175 A1
(43) Pub. Date: Nov. 19, 2026

(54) METHOD AND SYSTEM FOR OPTIMIZING ACCOUNT DATA RETRIEVAL

(71) Applicant: JPMorgan Chase Bank, N.A., New York, NY (US)

(72) Inventors: Kiran SEKHARAMAHANTHI, Newark, DE (US); Ashish LAMICHHANE, Glen Mills, PA (US); Varun MONGA, Bengaluru (IN)

(73) Assignee: JPMorgan Chase Bank, N.A., New York, NY (US)

(21) Appl. No.: 19/647,115

(22) Filed: Apr. 14, 2026

(30) Foreign Application Priority Data
May 19, 2025 (IN) 202511048079

(51) Int. Cl. G06F 16/2455; G06F 16/2457

(52) U.S. Cl. CPC G06F 16/24552; G06F 16/24575

(57) ABSTRACT

A method and a system for optimizing account data retrieval are provided. The method includes: receiving historical account activity data associated with a user from an online platform; analyzing, via a machine learning (ML) model, the historical account activity data to determine a behavioral pattern of account activity, including a respective frequency for which the user requests retrieval of each respective type of account data from among a plurality of different types of account data; calculating, via the ML model, based on a result of the analyzing, a respective probability value for receiving a retrieval request for each respective type of account data; determining, based on the calculated probability values, a predicted behavior of the user upon logging into the online platform; receiving, a login submission for the online platform from the user; and caching first account data corresponding to the predicted behavior.

### CROSS-REFERENCE TO RELATED APPLICATIONS

This application claims priority benefit from Indian Application No. 202511048079, filed on May 19, 2025, in the India Patent Office, which is hereby incorporated by reference in its entirety.

### FIELD OF THE DISCLOSURE

This disclosure generally relates to methods and systems for optimizing account data retrieval, and more particularly to methods and systems for analyzing historical account activity data using a machine learning (ML) model to identify the most likely behavior of a user in order to cache the appropriate data corresponding to this behavior.

### BACKGROUND INFORMATION

Certain banking applications and services serve as a repository for all customer transactions over a period of time (e.g., two years). These applications interface with multiple bank APIs to facilitate the retrieval of customer data across various platforms, including web, mobile, and agent interfaces. The process of retrieving a customer's transaction history can necessitate anywhere from 10 to 100 database calls, contingent upon the specific data requirements. Customers may seek information on Demand Deposit Accounts (DDA), credit cards, loans, or a combination thereof. Once a product is selected, customers may opt to access only their most recent statement cycle or view recent transactions, while others may require a review of several months of transaction history. Additionally, some customers may search through historical statements or look for specific keywords, such as "10$" or "DEBIT." Consequently, response times can vary significantly based on the nature of the request.

Currently a customer logs in to their online banking platform and sees their various cards/accounts. The customer may then click on one of the cards, which generates a call to an API, which then retrieves the transaction data over the last 24 months, sorts them, searches them, filters them, etc., and then provides the top 50 transactions. This current interaction and retrieval may take about 100ms and require over 100 API calls. In order to reduce this retrieval time, the system may attempt to cache this transactional data as soon as the customer logs in. However, if the customer has a large number of cards and accounts it becomes infeasible to cache the data for all these cards/accounts at once. Additionally, on a global scale this would take a large amount of processing, memory, resources, etc. to cache every customer’s transactional data, as soon as they log in, regardless of whether they plan to request/view that data or not.

Most customers when they log in, by default, only go to one of their accounts most of the time, and then go to the others a smaller percentage of the time. For example, for someone who trades regularly, they may generally access their brokerage account most often (e.g., 9 times out of 10) and then their credit card or debit card less often (e.g., 1 or 2 times out of 10). Similarly, customers with multiple credit and/or debit cards generally have one card that they use more than their other cards, and they generally access that account most frequently.

Accordingly, there is a need for a system that can profile each customer using a combination of machine learning algorithms and user-based profile history to identify and predict customer behaviors and prefetch the relevant data based on the prediction. Particularly, a method and system are needed for analyzing historical account activity data using an ML model to identify the most likely behavior of a user in order to cache the appropriate data corresponding to this behavior.

### SUMMARY

The present disclosure, through one or more of its various aspects, embodiments, and/or specific features or sub-components, provides, inter alia, various systems, servers, devices, methods, media, programs, and platforms for analyzing historical account activity data using an ML model to identify the most likely behavior of a user in order to cache the appropriate data corresponding to this behavior.

According to an aspect of the present disclosure, a method for optimizing account data retrieval is provided. The method may be implemented by at least one processor. The method may include: receiving, by the at least one processor, historical account activity data from an online platform, wherein the historical account activity data is associated with a user; analyzing, by the at least one processor and via an ML model, the historical account activity data to determine a behavioral pattern of account activity made by the user, wherein the behavioral pattern includes a respective frequency for which the user requests retrieval of each respective type of account data from among a plurality of different types of account data; calculating, by the at least one processor and via the ML model, based on a result of the analyzing, a respective probability value for receiving a retrieval request for each respective type of account data; determining, by the at least one processor, based on the calculated probability values, a predicted behavior of the user upon logging into the online platform; receiving, by the at least one processor, a login submission for the online platform from the user; and caching, by the at least one processor, first account data corresponding to the predicted behavior.

The method may further include identifying, by the at least one processor, based on a result of the calculating, a first retrieval request type having a first probability that exceeds a predetermined threshold value. The determining of the predicted behavior may be further based on the identifying of the first retrieval request type.

The method may further include generating, by the at least one processor, based on a result of the analyzing, an analytics profile for the user that identifies at least one behavioral characteristic of the user for each login by the user over a predetermined period of time. The determining of the predicted behavior may be further based on the analytics profile.

The method may further include: identifying, by the at least one processor, based on a result of the calculating, a first retrieval request type having a first probability that exceeds a predetermined threshold value; generating, by the at least one processor, based on a result of the analyzing, an analytics profile for the user that identifies at least one behavioral characteristic of the user for each login by the user over a predetermined period of time; and assigning, by the at least one processor, respective first predetermined weight values to each respective calculated probability value. The determining of the predicted behavior may be further based on the calculated probability values with the assigned respective first predetermined weight values and the analytics profile.

The retrieval request may comprise selecting a first account associated with the user from among a plurality of accounts associated with the user.

The plurality of accounts may comprise at least one from among a demand deposit account, a checking account, a savings account, a credit card account, a loan account, and a brokerage account.

The plurality of different types of account data may comprise at least one from among a listing of transactions, an account balance, an account category, an access history, a frequency of deposits, a frequency of withdrawals, a frequency of linking with aggregators, an account size, a user location, a user occupation, a user travel frequency, an account access frequency, a user age, a user segment type, and an access history.

According to another aspect of the present disclosure, a computing apparatus for optimizing account data retrieval is provided. The computing apparatus may include a processor; a memory; and a communication interface coupled to each of the processor, and the memory. The processor may be configured to: receive historical account activity data from an online platform, wherein the historical account activity data is associated with a user; analyze, via an ML model, the historical account activity data to determine a behavioral pattern of account activity made by the user, wherein the behavioral pattern includes a respective frequency for which the user requests retrieval of each respective type of account data from among a plurality of different types of account data; calculate, via the ML model, based on a result of the analyzing, a respective probability value for receiving a retrieval request for each respective type of account data; determine, based on the calculated probability values, a predicted behavior of the user upon logging into the online platform; receive a login submission for the online platform from the user; and cache first account data corresponding to the predicted behavior.

The processor may be further configured to identify, based on a result of the calculating, a first retrieval request type having a first probability that exceeds a predetermined threshold value. The determination of the predicted behavior may be further based on the identifying of the first retrieval request type.

The processor may be further configured to generate, based on a result of the analyzing, an analytics profile for the user that identifies at least one behavioral characteristic of the user for each login by the user over a predetermined period of time. The determination of the predicted behavior may be further based on the analytics profile.

The processor may be further configured to identify, based on a result of the calculating, a first retrieval request type having a first probability that exceeds a predetermined threshold value; generate, based on a result of the analyzing, an analytics profile for the user that identifies at least one behavioral characteristic of the user for each login by the user over a predetermined period of time; and assign respective first predetermined weight values to each respective calculated probability value. The determining of the predicted behavior is further based on the calculated probability values with the assigned respective first predetermined weight values and the analytics profile.

The retrieval request comprises selecting a first account associated with the user from among a plurality of accounts associated with the user.

The plurality of accounts comprises at least one from among a demand deposit account, a checking account, a savings account, a credit card account, a loan account, and a brokerage account.

The plurality of different types of account data comprise at least one from among a listing of transactions, an account balance, an account category, an access history, a frequency of deposits, a frequency of withdrawals, a frequency of linking with aggregators, an account size, a user location, a user occupation, a user travel frequency, an account access frequency, a user age, a user segment type, and an access history.

According to yet another aspect of the present disclosure, a non-transitory computer readable storage medium storing instructions for performing endpoint device recovery is provided. The storage medium includes executable code which, when executed by a processor, may cause the processor to: receive historical account activity data from an online platform, wherein the historical account activity data is associated with a user; analyze, via an ML model, the historical account activity data to determine a behavioral pattern of account activity made by the user, wherein the behavioral pattern includes a respective frequency for which the user requests retrieval of each respective type of account data from among a plurality of different types of account data; calculate, via the ML model, based on a result of the analyzing, a respective probability value for receiving a retrieval request for each respective type of account data; determine, based on the calculated probability values, a predicted behavior of the user upon logging into the online platform; receive a login submission for the online platform from the user; and cache first account data corresponding to the predicted behavior.

The executable code may further cause the processor to identify, based on a result of the calculating, a first retrieval request type having a first probability that exceeds a predetermined threshold value. The determination of the predicted behavior may be further based on the identifying of the first retrieval request type.

The executable code may further cause the processor to generate, based on a result of the analyzing, an analytics profile for the user that identifies at least one behavioral characteristic of the user for each login by the user over a predetermined period of time. The determination of the predicted behavior may be further based on the analytics profile.

The executable code may further cause the processor to identify, based on a result of the calculating, a first retrieval request type having a first probability that exceeds a predetermined threshold value; generate, based on a result of the analyzing, an analytics profile for the user that identifies at least one behavioral characteristic of the user for each login by the user over a predetermined period of time; and assign respective first predetermined weight values to each respective calculated probability value. The determining of the predicted behavior may be further based on the calculated probability values with the assigned respective first predetermined weight values and the analytics profile.

The retrieval request comprises selecting a first account associated with the user from among a plurality of accounts associated with the user.

The plurality of accounts comprises at least one from among a demand deposit account, a checking account, a savings account, a credit card account, a loan account, and a brokerage account.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for analyzing historical account activity data using an ML model to identify the most likely behavior of a user in order to cache the appropriate data corresponding to this behavior, according to an embodiment.

FIG. 2 illustrates a diagram of a network environment for analyzing historical account activity data using an ML model to identify the most likely behavior of a user in order to cache the appropriate data corresponding to this behavior, according to an embodiment.

FIG. 3 illustrates a system diagram of a system for analyzing historical account activity data using an ML model to identify the most likely behavior of a user in order to cache the appropriate data corresponding to this behavior, according to an embodiment.

FIG. 4 illustrates a process diagram of a process for analyzing historical account activity data using an ML model to identify the most likely behavior of a user in order to cache the appropriate data corresponding to this behavior, according to an embodiment.

FIG. 5 illustrates a system diagram for analyzing historical account activity data using an ML model to identify the most likely behavior of a user in order to cache the appropriate data corresponding to this behavior, according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units, and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or similar, they may be programmed using software (e.g., microcode) to perform various functions discussed herein and may optionally be driven by firmware and/or software. Alternatively, each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of the example embodiments may be physically separated into two or more interacting and discrete blocks, units, and/or modules without departing from the scope of the inventive concepts. Further, the blocks, units, and/or modules of the example embodiments may be physically combined into more complex blocks, units, and/or modules without departing from the scope of the present disclosure.

A system or method disclosed herein performs a series of operations for optimizing account data retrieval. Particularly, the system may analyze prior account activity of a user on an online platform. For example, the system may determine that 95% of the time when a user logs into their online banking platform, they access their credit card account and retrieve the transactions from the past month. The system may then identify this frequent activity as a pattern. Additionally, the system may determine that the user only accesses their debit card to look at past transactions 10% of the time. The system then calculates a probability value for each potential action the user may perform each time the user logs into the online platform. Based on these calculated probability values the system determines a predicted most likely behavior of the user each time they login. For example, the system may determine that most likely the user will access their credit card and request to retrieve the past month’s transaction data. This determined most likely behavior may be stored in a database or profile associated with the user. Then, each time the user logs into the online platform, the system immediately caches the data associated with the user’s most likely behavior. For example, upon logging in, the system may automatically cache the previous month’s transactions associated with the user’s credit card.

By analyzing the user’s account activity and behavior, the system is able to predict which data the user will likely request and cache that data, so it is immediately available upon the user logging in. Not only does this improve customer satisfaction by instantaneously providing relevant data to the customer, but it also helps improve speed, performance, efficiency, and functionality of the computer-based system. For example, the system improves the computer processing performance by identifying the exact information that each specific customer is likely to request and only prefetching that information, which reduces processing and utilization requirements. Particularly, by identifying and retrieving only relevant data, the system reduces both the amount of data that is required to be cached and the number of API calls required to retrieve requested data, as less overall data will be requested. Overall, this reduces resource utilization and processing power, which ultimately reduces costs.

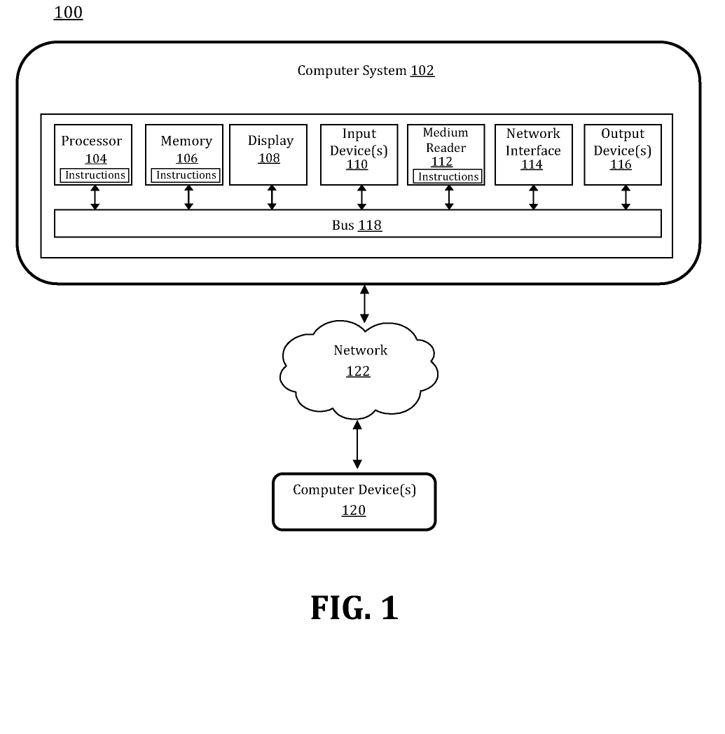

FIG. 1 is a system 100 for analyzing historical account activity data using an ML model to identify the most likely behavior of a user in order to cache the appropriate data corresponding to this behavior, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In an embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, and serial advanced technology attachment.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 may be a personal computer. However, those skilled in the art appreciate that, in alternative embodiments of the present application, the computer device 120 may also be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the data retrieval optimizing module implemented by the system 100 may allow for analyzing historical account activity data using an ML model to identify the most likely behavior of a user in order to cache the appropriate data corresponding to this behavior. The configuration or data files, in some embodiments, may be written using JavaScript Object Notation (JSON), but the disclosure is not limited thereto. For example, the configuration or data files may easily be extended to other readable file formats such as Extensible Markup Language (XML), Yet Another Markup Language (YAML), or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionalities as described herein, and a processor described herein may be used to support a virtual processing environment.

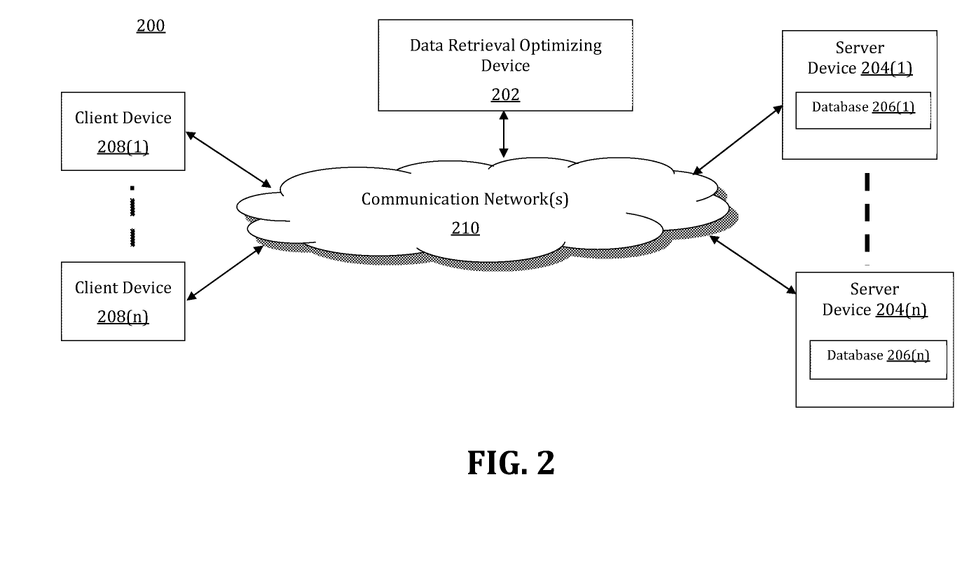

Referring to FIG. 2, a schematic of a network environment 200 for analyzing historical account activity data using an ML model to identify the most likely behavior of a user in order to cache the appropriate data corresponding to this behavior is illustrated.

In some embodiments, the above-described problems associated with conventional tools may be overcome by implementing a data retrieval optimizing device 202 as illustrated in FIG. 2 that may be configured for analyzing historical account activity data using an ML model to identify the most likely behavior of a user in order to cache the appropriate data corresponding to this behavior, but the disclosure is not limited thereto.

The data retrieval optimizing device 202 may include one or more computer systems 102, as described with respect to FIG. 1, which in aggregate provide the necessary functions.

The data retrieval optimizing device 202 may store one or more applications that can include executable instructions that, when executed by the data retrieval optimizing device 202, cause the data retrieval optimizing device 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the data retrieval optimizing device 202 itself, may be located in virtual server(s) running in a cloud-based computing environment rather than being tied to one or more specific physical network computing devices. Also, the application(s) may be running in one or more virtual machines (VMs) executing on the data retrieval optimizing device 202. Additionally, in one or more embodiments of this technology, virtual machine(s) running on the data retrieval optimizing device 202 may be managed or supervised by a hypervisor.

In the network environment 200 of FIG. 2, the data retrieval optimizing device 202 may be coupled to a plurality of server devices 204(1)-204(n) that hosts a plurality of databases 206(1)-206(n), and also to a plurality of client devices 208(1)-208(n) via communication network(s) 210. A communication interface of the data retrieval optimizing device 202, such as the network interface 114 of the computer system 102 of FIG. 1, operatively couples and communicates between the data retrieval optimizing device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the data retrieval optimizing device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use Transmission Control Protocol/Internet Protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The data retrieval optimizing device 202 may be a standalone device or integrated with one or more other devices or apparatuses, such as one or more of the server devices 204(1)-204(n), for example. In one example, the data retrieval optimizing device 202 may be hosted by one of the server devices 204(1)-204(n), and other arrangements are also possible. Moreover, one or more of the devices of the data retrieval optimizing device 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the data retrieval optimizing device 202 via the communication network(s) 210 according to the Hypertext Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) host the databases 206(1)-206(n) that are configured to store data sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the data retrieval optimizing device 202 that may analyze historical account activity data using an ML model to identify the most likely behavior of a user in order to cache the appropriate data corresponding to this behavior, but the disclosure is not limited thereto.

The client devices 208(1)-208(n) may run interface applications, such as standard web browsers or standalone client applications, which may provide an interface to communicate with the data retrieval optimizing device 202 via the communication network(s) 210 in order to communicate user requests. The client devices 208(1)-208(n) may further include, among other features, a display device, such as a display screen or touchscreen, and/or an input device, such as a keyboard, for example.

Although the network environment 200 with the data retrieval optimizing device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the data retrieval optimizing device 202, the server devices 204(1)-204(n), or the client devices 208(1)-208(n), for example, may be configured to operate as virtual instances on the same physical machine. For example, one or more of the data retrieval optimizing devices 202, the server devices 204(1)-204(n), or the client devices 208(1)-208(n) may operate on the same physical device rather than as separate devices communicating through communication network(s) 210. Additionally, there may be more or fewer data retrieval optimizing devices 202, server devices 204(1)-204(n), or client devices 208(1)-208(n) than illustrated in FIG. 2. In some embodiments, the data retrieval optimizing device 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

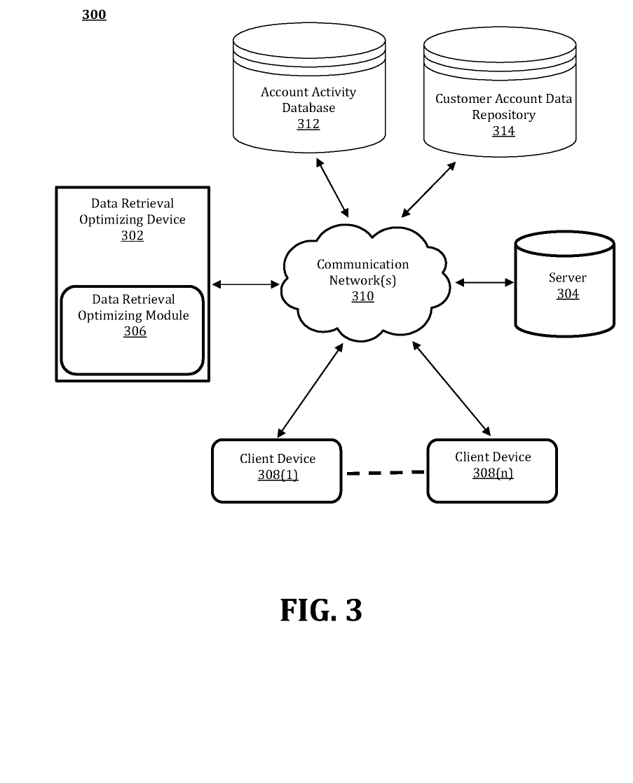

FIG. 3 illustrates a system diagram for analyzing historical account activity data using an ML model to identify the most likely behavior of a user in order to cache the appropriate data corresponding to this behavior, in accordance with an embodiment.

As illustrated in FIG. 3, the system 300 may include a data retrieval optimizing device 302 within which a data retrieval optimizing module 306 is embedded, a server 304, an account activity database 312, a customer account data repository 314, a plurality of client devices 308(1) … 308(n), and a communication network 310.

In some embodiments, the data retrieval optimizing device 302 including the data retrieval optimizing module 306 may be connected to the server 304, the account activity database 312, and the customer account data repository 314 via the communication network 310. The data retrieval optimizing device 302 may also be connected to the plurality of client devices 308(1) … 308(n) via the communication network 310, but the disclosure is not limited thereto. The account activity database 312 and the customer account data repository 314 may include one or more repositories or databases.

In an embodiment, the data retrieval optimizing device 302 is described and shown in FIG. 3 as including the data retrieval optimizing module 306, although it may include other rules, policies, modules, databases, or applications, for example. In some embodiments, the account activity database 312 and the customer account data repository 314 may be configured to store ready to use modules written for each API for all environments. Although only one database is illustrated in FIG. 3, the disclosure is not limited thereto. Any number of desired databases and/or repositories may be utilized for use in the disclosed invention herein. Each of the account activity database 312 and the customer account data repository 314 may be a mainframe database, a log database that may produce programming for searching, monitoring, and analyzing machine-generated data via a web interface, but the disclosure is not limited thereto. In addition, the account activity database 312 and the customer account data repository 314 may store a plurality of applications and resources for optimizing account data retrieval.

In some embodiments, the data retrieval optimizing module 306 may be configured to receive a real-time feed of data from the plurality of client devices 308(1) … 308(n) and secondary sources via the communication network 310.

The data retrieval optimizing module 306 may be configured to: receive historical account activity data from an online platform, wherein the historical account activity data is associated with a user; analyze, via an ML model, the historical account activity data to determine a behavioral pattern of account activity made by the user, wherein the behavioral pattern includes a respective frequency for which the user requests retrieval of each respective type of account data from among a plurality of different types of account data; calculate, via the ML model, based on a result of the analyzing, a respective probability value for receiving a retrieval request for each respective type of account data; determine, based on the calculated probability values, a predicted behavior of the user upon logging into the online platform; receive a login submission for the online platform from the user; and cache first account data corresponding to the predicted behavior.

The plurality of client devices 308(1) … 308(n) are illustrated as being in communication with the data retrieval optimizing device 302. In this regard, the plurality of client devices 308(1) … 308(n) may be “clients” (e.g., customers) of the data retrieval optimizing device 302 and are described herein as such. Nevertheless, it is to be known and understood that the plurality of client devices 308(1) … 308(n) need not necessarily be “clients” of the data retrieval optimizing device 302, or any entity described in association therewith herein. Any additional or alternative relationship may exist between either or both plurality of client devices 308(1) … 308(n) and the data retrieval optimizing device 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the pluralities of client devices 308(1) … 308(n) may communicate with the data retrieval optimizing device 302 via broadband or cellular communication. Of course, these embodiments are merely exemplary and are not limiting or exhaustive.

The client devices 308(1)-308(n) may be the same or similar to any one of the client devices 208(1)-208(n) as described with respect to FIG. 2, including any features or combination of features described with respect thereto. The data retrieval optimizing device 302 may be the same or similar to the data retrieval optimizing device 202 as described with respect to FIG. 2, including any features or combination of features described with respect thereto.

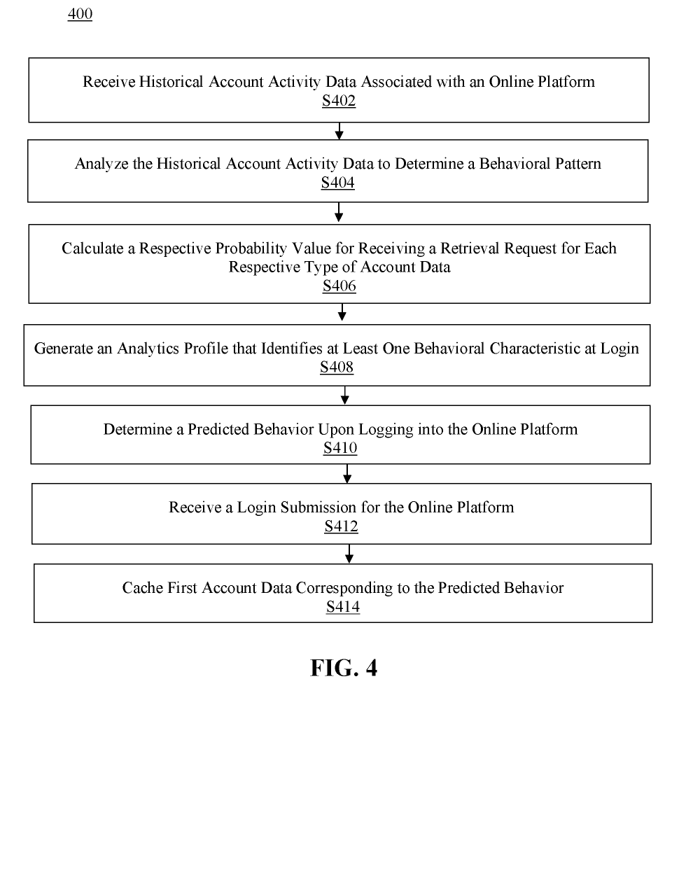

FIG. 4 illustrates a process 400 for analyzing historical account activity data using an ML model to identify the most likely behavior of a user in order to cache the appropriate data corresponding to this behavior, according to an embodiment.

In process 400 of FIG. 4, at step S402, the data retrieval optimizing device 302 may receive historical account activity data from an online platform. The historical account activity data may be associated with a specific user. In an embodiment, the online platform may be a website, application, or portal for accessing account data (e.g., a banking website). The historical account activity data may relate to the specific actions that the user has performed each time they log into the platform. For example, the historical account activity data may include each account accessed and/or specific request for data that the user has made over a predetermined time period. For example, over a period of time, the user may have logged into the online platform 100 times. Over those 100 log ins, the user may have accessed their credit card account 95 times and their debit card account 10 times. Additionally, during the 95 times the user accessed their credit card account, they may have requested the retrieval of their past 50 credit card transactions 90 times. All of this data may be provided in the historical account activity data. In an embodiment, the accounts accessed by the user may include a demand deposit account, a checking account, a savings account, a credit card account, a loan account, and a brokerage account.

At step S404, the data retrieval optimizing device 302 may analyze the historical account activity data to determine a behavioral pattern of account activity made by the user. In an embodiment, the analysis may be done via an ML model. The behavioral pattern may include a respective frequency for which the user requests retrieval of each respective type of account data from among a plurality of different types of account data. The plurality of different types of account data may include at least one from among a listing of transactions, an account balance, an account category, an access history, a frequency of deposits, a frequency of withdrawals, a frequency of linking with aggregators, an account size, a user location, a user occupation, a user travel frequency, an account access frequency, a user age, a user segment type, and an access history. For example, the data retrieval optimizing device 302 may use the ML model to analyze the historical account activity data and determine that most often when the user logs into the platform they go to their checking account and just retrieve the account balance.

At step S406, the data retrieval optimizing device 302 may calculate a respective probability value for receiving a retrieval request for each respective type of account data. The calculating may be done via an ML model and may be based on a result of the analysis. In an embodiment, the retrieval request may include the user selecting to retrieve specific account data (e.g., a balance, transactions data, deposit information, etc.) from one of their accounts. For example, the data retrieval optimizing device 302, via the ML model, may determine that the user has a 93% probability of requesting retrieval of their most recent credit card transactions and 5% probability of requesting retrieval of the most recent checking account deposits.

In some embodiments, the data retrieval optimizing device 302 may assign weight values to each respective calculated probability value. The weight values may be predetermined prior to their assignment. The weight values may be determined based on the corresponding ML model that is used for calculating the probability. The weight values may be determined based on their assessed improvement of the performance of the ML model.

At step S408, the data retrieval optimizing device 302 may generate an analytics profile for the user that identifies at least one behavioral characteristic of the user for each login over a predetermined period of time. The analytics profile may include an update on the total number of times over a predetermined period of time (e.g., 3 months, 6 months, one year, etc.) the user chooses a specific behavior with regard to account data retrieval. For example, in an embodiment, whenever the user logs in and uses one kind of product most often, the data retrieval optimizing device 302 outputs that pattern as the analytics profile. The analytics profile may then show, for example, for a particular user, out of all their accounts, their checking account is accessed 90% of the time.

In some embodiments, the data retrieval optimizing device 302 may assign weight values to the analytics profile statistics. The weight values may be predetermined prior to their assignment. The weight values may be determined based on the model used for generating the analytics profile. The weight values may be determined based on their assessed improvement of the performance of the analytics model.

At step S410, the data retrieval optimizing device 302 may determine a predicted behavior of the user upon logging into the online platform. This predicted behavior may be based on at least one from among the calculated probability values and the generated analytics profile. For example, the data retrieval optimizing device 302 may analyze both the calculated probability values and the generated analytics profile to determine what action by the user is most likely to occur when the user logs into the online platform. Particularly, the data retrieval optimizing device 302 may determine which account data is likely to be requested to be retrieved by the user with the highest probability.

In an embodiment, the data retrieval optimizing device 302 may compare each calculated probability value to a predetermined threshold. Then, if the probability value exceeds the predetermined threshold, the data retrieval optimizing device 302 identifies the corresponding retrieval requests as a likely behavior. For example, the predetermined threshold value may be set to 90% or greater, if the data retrieval optimizing device 302 determines that there is a 93% probability of requesting retrieval of recent credit card transactions, it will identify this request as the likely behavior. This identification may also be used for determining the predicted behavior.

In some embodiments, the determining of the predicted behavior may also take into account at least one selected from among the weight values assigned to the analytics profile statistics and the weight values assigned to each respective calculated probability value. For example, corresponding weighted analytics profile statistic values and corresponding weighted probability values can be added together and averaged to determine the predicted behavior.

At step S412, the data retrieval optimizing device 302 may receive a login submission for the online platform from the user. In other words, the user logs into the online platform.

Then, at step S414, the data retrieval optimizing device 302 may cache account data that corresponds to the predicted behavior. In other words, the data retrieval optimizing device 302 prefetches the data that has the highest probability of being requested by the user, so that this data is ready and can be accessed immediately by the user (e.g., less than 1.0 second and more optimally equal to or less than 50 milliseconds).

In an embodiment, once the user opens or clicks on the data or information that was cached at step S414, the data retrieval optimizing device 302 may then cache the rest of the transaction data associated with the user’s account(s) and card(s), so that the user’s other transaction data is ready for quick / near-instantaneous retrieval (e.g., less than 1.0 second and more optimally equal to or less than 50 milliseconds).

Currently, retrieving a customer’s top transactions requires first retrieving, filtering, and sorting the previous two years of transactional data. This process requires more than a 100 API calls/queries. However, not every user or customer is going to look at transactions, they may want to check their account balance but not look at their transactions. For example, there are a large number of customers that just look at their account balance or some other feature of the app and rarely request the retrieval of transactions. By recognizing this probability and identifying patterns for each customer, the system is able to reduce the processing and retrieving volume. This allows the system to not have to prefetch or cache transactions for every customer, which is a huge infrastructural burden, particularly when a number of customers will not even request this information. Getting transactional data requires a lot of processing power. The data retrieval optimizing device 302 is able to narrow down to only the customers having a high probability of requesting transactional data retrieval, and only prefetch transactions for those customers beforehand. Additionally, if the system knows that the customer only wants the past 50 transactions, this only requires a single application programming interface (API) call/query versus the current 100+ calls required.

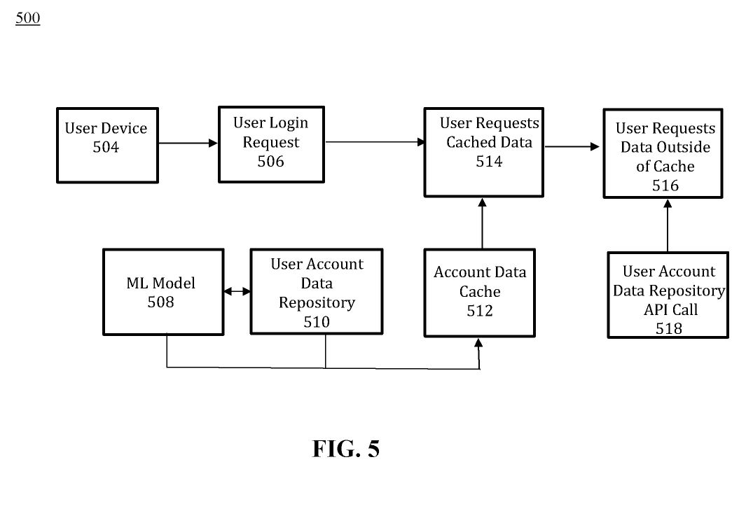

FIG. 5 illustrates a system diagram 500 for analyzing historical account activity data using an ML model to identify the most likely behavior of a user in order to cache the appropriate data corresponding to this behavior, according to an embodiment.

In process 500 of FIG. 5, a user device module 504 transmits a user login request to an online platform at module 506. Prior to or concurrent with the user login request at module 506, an ML model 508 and a user account data repository 510 are in communication. The ML model 508 analyzes the user account data repository 510 to determine a predicted behavior of the user. The appropriate account data corresponding to the predicted behavior is stored as account data cache at module 512. At module 514 the user requests and instantaneously receives cached data from the account data cache module 512. At module 516 the user requests data outside of the cached data and an API call is made to the user account data repository at module 518. Thus, the system diagram 500 allows for the analyzing of historical account activity data using an ML model to identify the most likely behavior of a user in order to cache the appropriate data corresponding to this behavior, according to an embodiment.

Accordingly, with this technology, an optimized process for analyzing historical account activity data using an ML model to identify the most likely behavior of a user in order to cache the appropriate data corresponding to this behavior is provided.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for optimizing account data retrieval, the method being implemented by at least one processor, the method comprising:
receiving, by the at least one processor, historical account activity data from an online platform, wherein the historical account activity data is associated with a user;
analyzing, by the at least one processor and via a machine learning (ML) model, the historical account activity data to determine a behavioral pattern of account activity made by the user, wherein the behavioral pattern includes a respective frequency for which the user requests retrieval of each respective type of account data from among a plurality of different types of account data;
calculating, by the at least one processor and via the ML model, based on a result of the analyzing, a respective probability value for receiving a retrieval request for each respective type of account data;
determining, by the at least one processor, based on the calculated probability values, a predicted behavior of the user upon logging into the online platform;
receiving, by the at least one processor, a login submission for the online platform from the user; and
caching, by the at least one processor, first account data corresponding to the predicted behavior.

2. The method of claim 1, further comprising:
identifying, by the at least one processor, based on a result of the calculating, a first retrieval request type having a first probability that exceeds a predetermined threshold value,
wherein the determining of the predicted behavior is further based on the identifying of the first retrieval request type.

3. The method of claim 1, further comprising:
generating, by the at least one processor, based on a result of the analyzing, an analytics profile for the user that identifies at least one behavioral characteristic of the user for each login by the user over a predetermined period of time,
wherein the determining of the predicted behavior is further based on the analytics profile.

4. The method of claim 1, further comprising:
identifying, by the at least one processor, based on a result of the calculating, a first retrieval request type having a first probability that exceeds a predetermined threshold value;
generating, by the at least one processor, based on a result of the analyzing, an analytics profile for the user that identifies at least one behavioral characteristic of the user for each login by the user over a predetermined period of time; and
assigning, by the at least one processor, respective first predetermined weight values to each respective calculated probability value,
wherein the determining of the predicted behavior is further based on the calculated probability values with the assigned respective first predetermined weight values and the analytics profile.

5. The method of claim 1, wherein the retrieval request comprises selecting a first account associated with the user from among a plurality of accounts associated with the user.

6. The method of claim 5, wherein the plurality of accounts comprises at least one from among a demand deposit account, a checking account, a savings account, a credit card account, a loan account, and a brokerage account.

7. The method of claim 1, wherein the plurality of different types of account data comprise at least one from among a listing of transactions, an account balance, an account category, an access history, a frequency of deposits, a frequency of withdrawals, a frequency of linking with aggregators, an account size, a user location, a user occupation, a user travel frequency, an account access frequency, a user age, a user segment type, and an access history.

8. A computing apparatus for optimizing account data retrieval, the computing apparatus comprising:
a processor;
a memory;
a display; and
a communication interface coupled to each of the processor, the memory, and the display,
wherein the processor is configured to:
receive historical account activity data from an online platform, wherein the historical account activity data is associated with a user;
analyze, via a machine learning (ML) model, the historical account activity data to determine a behavioral pattern of account activity made by the user, wherein the behavioral pattern includes a respective frequency for which the user requests retrieval of each respective type of account data from among a plurality of different types of account data;
calculate, via the ML model, based on a result of the analyzing, a respective probability value for receiving a retrieval request for each respective type of account data;
determine, based on the calculated probability values, a predicted behavior of the user upon logging into the online platform;
receive a login submission for the online platform from the user; and
cache first account data corresponding to the predicted behavior.

9. The computing apparatus of claim 8, wherein the processor is further configured to:
identify, based on a result of the calculating, a first retrieval request type having a first probability that exceeds a predetermined threshold value,
wherein the determination of the predicted behavior is further based on the identifying of the first retrieval request type.

10. The computing apparatus of claim 8, wherein the processor is further configured to:
generate, based on a result of the analyzing, an analytics profile for the user that identifies at least one behavioral characteristic of the user for each login by the user over a predetermined period of time,
wherein the determining of the predicted behavior is further based on the analytics profile.

11. The computing apparatus of claim 8, wherein the processor is further configured to:
identify, based on a result of the calculating, a first retrieval request type having a first probability that exceeds a predetermined threshold value;
generate, based on a result of the analyzing, an analytics profile for the user that identifies at least one behavioral characteristic of the user for each login by the user over a predetermined period of time; and
assign respective first predetermined weight values to each respective calculated probability value,
wherein the determining of the predicted behavior is further based on the calculated probability values with the assigned respective first predetermined weight values and the analytics profile.

12. The computing apparatus of claim 8, wherein the retrieval request comprises selecting a first account associated with the user from among a plurality of accounts associated with the user.

13. The computing apparatus of claim 12, wherein the plurality of accounts comprises at least one from among a demand deposit account, a checking account, a savings account, a credit card account, a loan account, and a brokerage account.

14. The computing apparatus of claim 8, wherein the plurality of different types of account data comprise at least one from among a listing of transactions, an account balance, an account category, an access history, a frequency of deposits, a frequency of withdrawals, a frequency of linking with aggregators, an account size, a user location, a user occupation, a user travel frequency, an account access frequency, a user age, a user segment type, and an access history.

15. A non-transitory computer readable storage medium storing instructions for optimizing account data retrieval, the non-transitory computer readable storage medium comprising executable code which, when executed by a processor, causes the processor to:
receive historical account activity data from an online platform, wherein the historical account activity data is associated with a user;
analyze, via a machine learning (ML) model, the historical account activity data to determine a behavioral pattern of account activity made by the user, wherein the behavioral pattern includes a respective frequency for which the user requests retrieval of each respective type of account data from among a plurality of different types of account data;
calculate, via the ML model, based on a result of the analyzing, a respective probability value for receiving a retrieval request for each respective type of account data;
determine, based on the calculated probability values, a predicted behavior of the user upon logging into the online platform;
receive a login submission for the online platform from the user; and
cache first account data corresponding to the predicted behavior.

16. The non-transitory computer readable storage medium of claim 15, wherein the executable code further causes the processor to:
identify, based on a result of the calculating, a first retrieval request type having a first probability that exceeds a predetermined threshold value,
wherein the determination of the predicted behavior is further based on the identifying of the first retrieval request type.

17. The non-transitory computer readable storage medium of claim 15, wherein the executable code further causes the processor to:
generate, based on a result of the analyzing, an analytics profile for the user that identifies at least one behavioral characteristic of the user for each login by the user over a predetermined period of time,
wherein the determining of the predicted behavior is further based on the analytics profile.

18. The non-transitory computer readable storage medium of claim 15, wherein the executable code further causes the processor to:
identify, based on a result of the calculating, a first retrieval request type having a first probability that exceeds a predetermined threshold value;
generate, based on a result of the analyzing, an analytics profile for the user that identifies at least one behavioral characteristic of the user for each login by the user over a predetermined period of time; and
assign respective first predetermined weight values to each respective calculated probability value,
wherein the determining of the predicted behavior is further based on the calculated probability values with the assigned respective first predetermined weight values and the analytics profile.

19. The non-transitory computer readable storage medium of claim 15, wherein the retrieval request comprises selecting a first account associated with the user from among a plurality of accounts associated with the user.

20. The non-transitory computer readable storage medium of claim 19, wherein the plurality of accounts comprises at least one from among a demand deposit account, a
checking account, a savings account, a credit card account, a loan account, and a brokerage account.
